(19) United States
(12) Patent Application Publication
(10) Pub. No.: US 2024/0343263 A1
(43) Pub. Date: Oct. 17, 2024

(54) VEHICLE DISPLAY CONTROL DEVICE

(71) Applicant: TOYOTA JIDOSHA KABUSHIKI KAISHA, Toyota-shi (JP)

(72) Inventors: Kohji MIYAZAKI, Toyota-shi (JP); Shunsuke OYAMA, Nagakute-shi (JP); Ryohei YUASA, Okazaki-shi (JP)

(73) Assignee: TOYOTA JIDOSHA KABUSHIKI KAISHA, Toyota-shi (JP)

(21) Appl. No.: 18/406,341

(22) Filed: Jan. 8, 2024

(30) Foreign Application Priority Data
Apr. 11, 2023 (JP) 2023-064424

(51) Int. Cl. B60W 50/14; B60W 60/00

(52) U.S. Cl. CPC B60W 50/14; B60W 60/0023; B60W 60/0051; B60W 2050/007; B60W 2050/146; B60W 2710/242; B60W 2720/24

(57) ABSTRACT

In a vehicle display control device installed in a vehicle that can switch the driving mode between a manual driving mode and an automatic driving mode, and which controls a display device installed in the vehicle cabin of the vehicle, when the drive mode switches from the manual driving mode to the automatic driving mode, the display mode of the display device is switched from the first display mode corresponding to the manual driving mode to the second display mode corresponding to the automatic driving mode, and in the second display mode, at least information indicating the amount of energy savings achieved by driving in the automatic driving mode is displayed.

### CROSS-REFERENCE TO RELATED APPLICATION

This application claims priority to Japanese Patent Application No. 2023-064424 filed on Apr. 11, 2023, incorporated herein by reference in its entirety.

### BACKGROUND

### 1. Technical Field

The present disclosure relates to a vehicle display control device.

### 2. Description of Related Art

Japanese Unexamined Patent Application Publication No. 2021-131356 (JP 2021-131356 A) discloses a display control device mounted on a vehicle capable of switching the driving mode between a manual driving mode and an autonomous driving mode, in which the display mode of a display device is switched according to the driving mode.

### SUMMARY

In the configuration described in JP 2021-131356 A, however, when the driving mode is the autonomous driving mode, the display content displayed on the display device does not provide sufficient information useful for an occupant riding in the vehicle driven autonomously. Therefore, there is room for improvement in the content displayed on the display device during the autonomous driving mode and in the display manner.

The present disclosure has been made in view of the above circumstances, and has an object to provide a vehicle display control device that can clearly convey the benefits of driving a vehicle in an autonomous driving mode to an occupant of the vehicle.

An aspect of the present disclosure provides a vehicle display control device mounted on a vehicle capable of switching a driving mode between a manual driving mode and an autonomous driving mode, the control device controlling a display device provided in a vehicle cabin of the vehicle, in which:
a display mode of the display device is switched from a first display mode corresponding to the manual driving mode to a second display mode corresponding to the autonomous driving mode when the driving mode is switched from the manual driving mode to the autonomous driving mode; and
information indicating at least an amount of saved energy achieved by traveling in the autonomous driving mode is displayed in the second display mode.

According to this configuration, the information displayed on the display device during the autonomous driving mode is different from the information displayed in the first display mode corresponding to the manual driving mode. In addition, information indicating the amount of saved energy achieved by traveling in the autonomous driving mode is displayed on the display device in the second display mode. Consequently, it is possible to clearly convey the benefits of driving the vehicle in the autonomous driving mode to an occupant of the vehicle.

An image indicating a cruising range of the vehicle during travel in the manual driving mode may be displayed in a display area of the display device in a first display manner as a predetermined display manner in the first display mode; and an image indicating the amount of saved energy achieved by traveling in the autonomous driving mode may be displayed in a central display area of the display area in a second display manner that is more conspicuous than the first display manner in the second display mode.

According to this configuration, an image indicating the amount of saved energy achieved by traveling in the autonomous driving mode can be displayed in the central display area of the display device in the second display manner that is more conspicuous than the first display manner.

The vehicle may be an electrified vehicle that includes a motor for travel and a battery that supplies power to the motor;
the second display mode may include a third display mode in which information related to the battery is preferentially displayed; and
an image indicating the amount of saved energy achieved by traveling in the autonomous driving mode and an image indicating a cruising range during travel of the vehicle with use of the power of the battery may be displayed in the central display area in the second display manner in the third display mode.

According to this configuration, when the electrified vehicle travels in the autonomous driving mode, images indicating the amount of saved energy achieved by traveling in the autonomous driving mode and the cruising range in EV travel can be displayed in the central display area of the display device in the second display manner that is more conspicuous than the first display manner.

The second display mode may include a normal display mode in which an image is displayed in the first display manner similar to the first display mode; and the third display mode may be given priority over the normal display mode as the display mode of the display device when the driving mode is the autonomous driving mode.

According to this configuration, the third display mode can be given priority over the normal display mode during the autonomous driving mode.

The second display mode may include
a normal display mode in which an image is displayed in the first display manner similar to the first display mode, and
a fourth display mode in which environmental information and economic information are preferentially displayed;
an image indicating the amount of saved energy achieved by traveling in the autonomous driving mode and an image indicating an electrical efficiency may be displayed in the central display area in the second display manner in the fourth display mode; and
the fourth display mode may be given priority over the normal display mode as the display mode of the display device when the driving mode is the autonomous driving mode.

According to this configuration, the fourth display mode can be given priority over the normal display mode during the autonomous driving mode.

According to the present disclosure, the information displayed on the display device during the autonomous driving mode is different from the information displayed in the first display mode corresponding to the manual driving mode. In addition, information indicating the amount of saved energy achieved by traveling in the autonomous driving mode is displayed on the display device in the second display mode. Consequently, it is possible to clearly convey the benefits of driving the vehicle in the autonomous driving mode to an occupant of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the overall configuration of a vehicle in an embodiment;

FIG. 2 is a block diagram for explaining the configuration of the display control ECU;

FIG. 3 is an explanatory diagram showing a display example in the normal display mode;

FIG. 4 is an explanatory diagram showing a display example of the battery information priority mode; and

FIG. 5 is an explanatory diagram showing a display example of the environment/economic information priority mode.

### DETAILED DESCRIPTION OF EMBODIMENTS

Hereinafter, a vehicle display control device according to an embodiment of the present disclosure will be specifically described. The present disclosure is not limited to the embodiments described below.

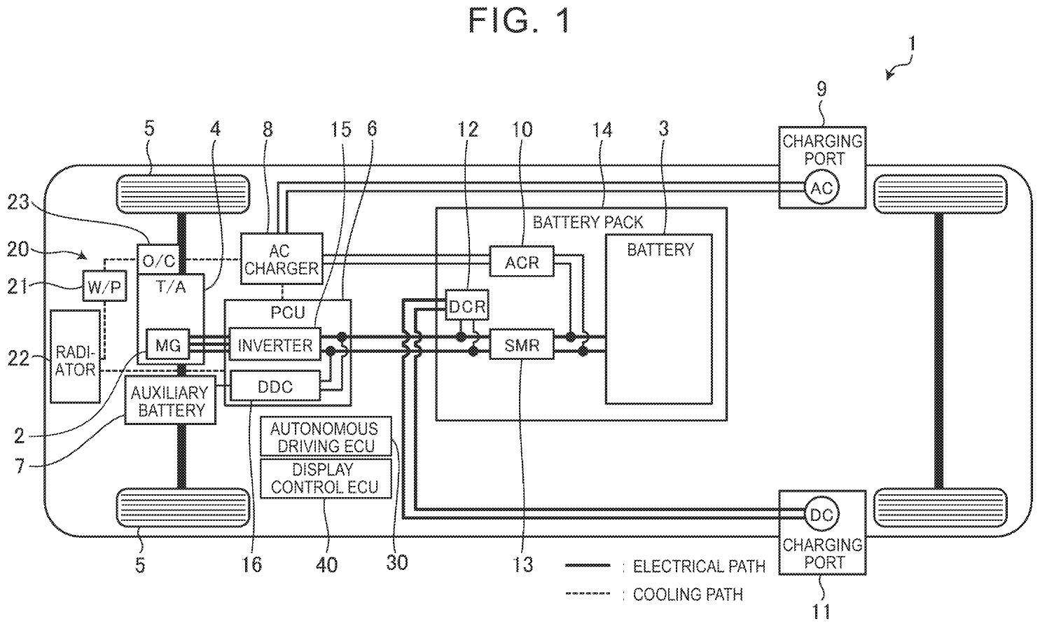

FIG. 1 is a diagram schematically showing the overall configuration of a vehicle in an embodiment. The vehicle 1 includes a motor (MG) 2 that is a power source, and a battery 3 that stores electric power to be supplied to the motor 2. The vehicle 1 travels by supplying electric power from the battery 3 to the motor 2 to drive the motor 2. In this vehicle 1, power output from a motor 2 is transmitted to wheels 5 via a transaxle (T/A) 4. For example, the vehicle 1 is configured by a battery electric vehicle (BEV), a hybrid electric vehicle (HEV), a plug-in hybrid electric vehicle (PHEV), or the like.

The vehicle 1 also includes a power control unit (hereinafter referred to as PCU) 6, an auxiliary battery 7, an AC charger 8, an AC charging port 9, an AC relay (hereinafter referred to as ACR) 10, and a DC charging port. 11, a DC relay (hereinafter referred to as DCR) 12, and a system main relay (hereinafter referred to as SMR) 13. The vehicle 1 is equipped with a battery pack 14 including a battery 3, an ACR 10, a DCR 12, and an SMR 13. This vehicle 1 is capable of charging the battery 3 with power supplied from an external power source. A vehicle 1 shown in FIG. 1 is an electrified vehicle that can be charged externally.

PCU 6 is a power conversion unit that includes an inverter 15 that drives motor 2 and a DCDC converter (DDC) 16 that supplies power to auxiliary battery 7. Motor 2 is electrically connected to battery 3 via inverter 15. The battery 3 is a high voltage battery that stores electric power to supply to the motor 2. The battery 3 is constituted by a secondary battery such as a lithium ion battery or a lead acid battery, for example. This battery 3 includes a battery module including a plurality of battery cells. The inverter 15 converts the electric power of the battery 3 and supplies it to the motor 2. The inverter 15 has a plurality of switching elements, and is configured so that the switching elements perform a switching operation.

The auxiliary battery 7 is a low-voltage battery that discharges and charges low-voltage power that allows the auxiliary machine to operate. The auxiliary battery 7 is composed of a secondary battery such as a lithium ion battery or a lead acid battery. Auxiliary battery 7 is electrically connected to DCDC converter 16 via a low voltage line. The power output from the DCDC converter 16 can be charged to the auxiliary battery 7. The voltage of the auxiliary battery 7 is lower than the voltage of the battery 3 included in the battery pack 14. The voltage of the auxiliary battery 7 is, for example, about 12V. The DCDC converter 16 is a converter that functions as an auxiliary device DCDC. Further, the DCDC converter 16 is electrically connected to the battery 3. The battery 3 can supply high voltage power to the DCDC converter 16. The DCDC converter 16 steps down the high DC voltage of the battery 3 to a low DC voltage, and supplies the stepped down DC voltage to the auxiliary battery 7.

For AC charging, the vehicle 1 supplies AC power supplied from an external AC power source to the battery 3 via an AC charging port 9, an AC charger 8, and an ACR 10. The battery 3 can be charged by the supplied power. For example, in a power supply stand equipped with an AC power source as an external power source, an AC charging cable of the power supply stand is connected to the AC charging port 9. AC charging port 9 is electrically connected to AC charger 8. AC charger 8 converts AC power supplied from an external AC charging cable through AC charging port 9 into DC power. ACR 10 is a charging relay provided between AC charger 8 and battery 3. When the ACR 10 is closed, the DC power converted by the AC charger 8 is supplied from the AC charger 8 to the battery 3 via the ACR 10.

Vehicle 1 supplies DC power supplied from an external DC power source to battery 3 via DC charging port 11, DCR 12, and SMR 13 for DC charging. The battery 3 can be charged by the supplied power. For example, in a power supply stand equipped with a DC power source as an external power source, a DC charging cable of the power supply stand is connected to the DC charging port 11. The DC charging port 11 is electrically connected to the DCR 12. DCR 12 is a charging relay provided between DC charging port 11 and SMR 13. SMR 13 is a relay provided between DCR 12 and battery 3. When the DCR 12 is closed and the SMR 13 is closed, DC power supplied from an external DC power source via the DC charging port 11 is supplied from the DCR 12 to the battery 3 via the SMR 13.

The vehicle 1 also includes a cooling circuit 20 in which coolant for cooling the PCU 6 circulates. An AC charger 8 is included in the cooling circuit 20. Cooling circuit 20 cools PCU 6 and AC charger 8 with coolant. The cooling circuit 20 includes a water pump (W/P) 21, a radiator 22, and an oil cooler (O/C) 23.

The water pump 21 discharges coolant from its discharge port and forces the coolant into the cooling circuit 20. coolant discharged from the water pump 21 is supplied to the radiator 22. The radiator 22 is a heat exchanger that exchanges heat between the coolant and the outside air, and radiates the heat of the coolant to the outside air. coolant-cooled by the radiator 22 is supplied to the PCU 6. After cooling the PCU 6, the coolant flows into the AC charger 8. coolant after cooling the AC charger 8 flows into the oil cooler 23. The oil cooler 23 is a heat exchanger that exchanges heat between the oil in the transaxle 4 and the cooling coolant in the cooling circuit 20. The oil in the transaxle 4 is cooled by the oil cooler 23. The oil in the transaxle 4 is contained in the transaxle case, and is oil that functions as a lubricating oil that lubricates the transaxle 4 and a cooling oil that cools the motor 2. A transaxle 4 and a motor 2 are housed in the transaxle case. coolant after heat exchange in the oil cooler 23 is sucked into the water pump 21 through its suction port.

The vehicle 1 also includes an autonomous driving ECU 30 and a display control ECU 40.

The autonomous driving ECU 30 is an electronic control device that controls automatic driving of the vehicle 1. The autonomous driving ECU 30 includes a processor and a memory. The processor consists of a CPU and the like. Memory is a main storage device, and consists of RAM, ROM, etc. The autonomous driving ECU 30 loads a program stored in the storage unit into the working area of memory (main memory) and executes it, and controls each component through the execution of the program to achieve a predetermined purpose. Achieve functionality. Signals from various sensors mounted on the vehicle 1 are input to the autonomous driving ECU 30. The autonomous driving ECU 30 executes automatic driving control based on signals input from various sensors.

Specifically, the vehicle 1 can run by switching the driving mode between a manual driving mode and an automatic driving mode. When the driving mode is the manual driving mode, the vehicle 1 travels by a driver riding in the vehicle 1 manually performing a driving operation. When the driving mode is the automatic driving mode, the vehicle 1 runs as the autonomous driving ECU 30 executes automatic driving control without requiring any driving operation by the driver. In the automatic driving mode, at least a portion of acceleration/deceleration and steering can be controlled without operation by the driver. When executing automatic operation control, the autonomous driving ECU 30 outputs control signals to various actuators to control the operations of the various actuators. Actuators controlled by autonomous driving ECU 30 include a drive actuator, a brake actuator, and a steering actuator.

The drive actuator is an actuator that outputs power of the vehicle 1. The brake actuator is an actuator that generates a braking force for the vehicle 1. The steering actuator is an actuator that changes the steering angle of the steering wheel. Since the motor 2 is a power source for the vehicle 1 and is capable of regenerative braking, it is included in the drive actuator and the brake actuator.

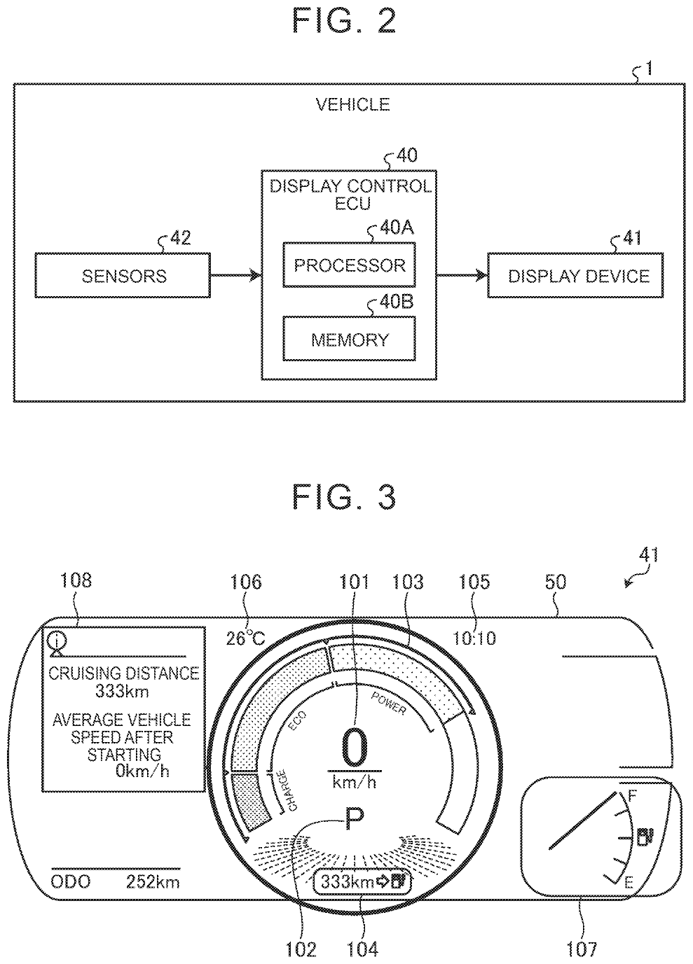

The display control ECU 40 is an electronic control device that controls the display contents of the display device 41, as shown in FIG. 2. The display control ECU 40 is a control device mounted on the vehicle 1 that can switch the driving mode between a manual driving mode and an automatic driving mode. The display control ECU 40 is a vehicle display control device that controls a display device 41 provided in the vehicle cabin of the vehicle 1.

The display control ECU 40 includes a processor 40A and a memory 40B. The display control ECU 40 has the same hardware configuration as the autonomous driving ECU 30. The processor 40A includes a CPU and the like. The memory 40B is a main storage device and includes RAM, ROM, and the like. The display control ECU 40 loads the program stored in the storage unit into the work area of the memory 40B and executes it, and controls each component through the execution of the program to achieve functions that meet a predetermined purpose. Signals from various sensors 42 mounted on the vehicle 1 are input to the display control ECU 40. The display control ECU 40 executes display control based on signals input from the sensors 42.

The display device 41 is a display placed inside the vehicle cabin of the vehicle 1. The display device 41 includes a meter panel capable of displaying meters such as a speedometer toward the driver. Furthermore, the display device 41 displays information input from the display control ECU 40 within the display area. The display content displayed on the display device 41 is controlled by a display control ECU 40.

The display control ECU 40 switches the display mode of the display device 41 according to the driving mode of the vehicle 1. The display modes include a first display mode that is selected when the driving mode is manual driving mode, and a second display mode that is selected when the driving mode is automatic driving mode. The display content and display manner displayed on the display device 41 are different between the first display mode and the second display mode. The display mode includes image size, color, brightness, blinking, etc. When the operation mode is the manual operation mode, the display control ECU 40 determines the display mode to be the normal display mode (first display mode). When the driving mode is switched from the manual driving mode to the automatic driving mode, the display control ECU 40 changes the display mode of the display device 41 from the first display mode corresponding to the manual driving mode to the second display mode corresponding to the automatic driving mode. Switch automatically.

More specifically, the first display mode includes a normal display mode. The normal display mode is a basic mode in which various information is displayed in a first display mode that is a predetermined display mode. In the normal display mode as the first display mode, it is possible to display an image indicating the possible cruising distance of the vehicle 1 running in the manual driving mode in the display area of the display device 41 in the first display mode.

As shown in FIG. 3, in the normal display mode, a vehicle speed 101, a shift position 102, and a ring-shaped power meter 103 are mainly displayed in the central display area of the display unit 50 of the display device 41. Although the drivable distance 104, clock 105, and outside temperature 106 are displayed in the central display area of the display unit 50, the drivable distance 104, clock 105, and outside temperature 106 are smaller than the vehicle speed 101 and shift position 102. It is displayed small. In addition, in the display mode of the normal display mode, the layout is such that the remaining amount meter 107 of the battery 3 and the multi-information display area 108 are arranged outside the central display area of the display unit 50. The size of the characters displayed on the battery 3 remaining amount gauge 107 and the multi-information display area 108 is smaller than the size of the characters displayed on the vehicle speed 101 and the shift position 102. The multi-information display area 108 displays the available cruising distance and the average vehicle speed after starting.

In the second display mode, an image showing the amount of energy savings achieved by driving in the automatic driving mode is displayed in the central display area of the display device 41 in a second display mode that is more conspicuous than the first display mode. do. The second display mode includes a battery information priority mode and an environmental/economic information priority mode. The battery information priority mode is a third display mode in which information related to the battery 3 is displayed preferentially. The environmental/economic information priority mode is a fourth display mode that preferentially displays environmental information and economic information. The display control ECU 40 has a first display mode, which is a normal display mode, a second display mode and a third display mode, which is a battery information priority mode, and a second display mode and a fourth display mode, which is an environmental/economic information priority mode. You can switch between modes. Note that the second display mode is not limited to the central display area, and may display the energy saving amount in any display area of the display device 41.

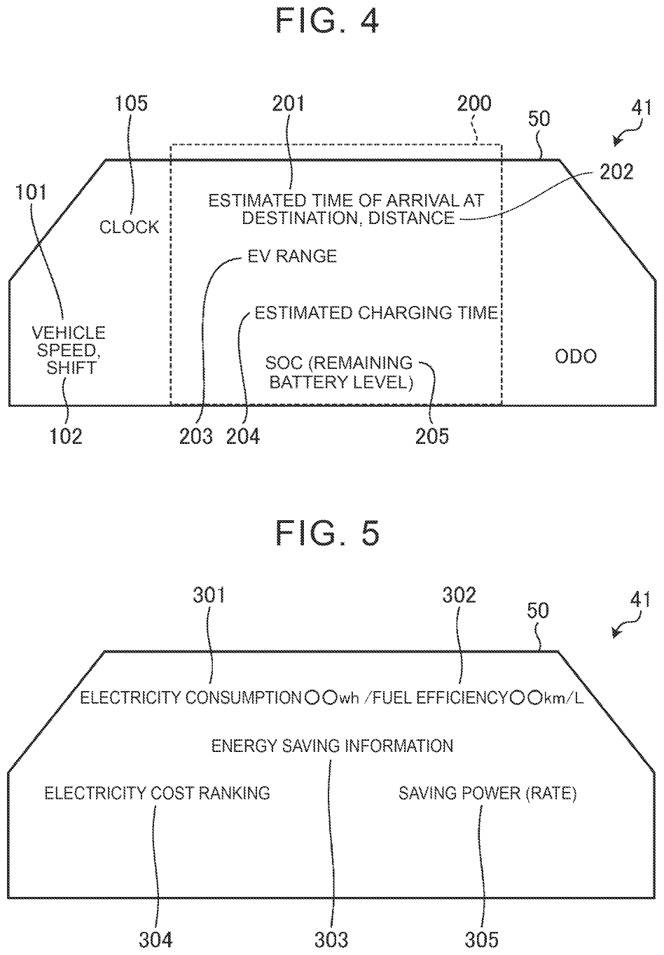

As shown in FIG. 4, in the battery information priority mode, the display contents and layout displayed on the display unit 50 are different from those in the first display mode. In the display mode of the battery information priority mode, the layout is such that the battery information 200 is mainly displayed in the central display area of the display unit 50. Battery information 200 is information related to battery 3. The battery information 200 includes a scheduled destination arrival time 201, a distance to the destination 202, an EV cruising range 203, a scheduled charging time 204, and an SOC 205. In the battery information mode, the clock 105, vehicle speed 101, and shift position 102 are arranged outside the central display area of the display unit 50 where the battery information 200 is displayed. Further, in the battery information mode, the size of the characters displayed in the battery information 200 is larger than the size of the characters in the vehicle speed 101 and the shift position 102.

As shown in FIG. 5, in the environment/economic information priority mode, the display content and layout displayed on the display unit 50 are different in both the first display mode and the battery information priority mode. In the display mode of the environmental/economic information priority mode, the layout is such that environmental information and economic information are mainly displayed in the central display area of the display unit 50. The environmental information and economic information include electricity consumption 301, fuel efficiency 302, energy saving information 303, electricity cost ranking 304, and power saving power (rate) 305. In the environment/economic information priority mode, at least one of the electricity consumption 301, fuel consumption 302, and energy saving information 303 is displayed on the display unit 50 as the amount of energy saved by the vehicle 1 traveling in the automatic driving mode. An example of the amount of energy saved is the amount of energy saved by switching from manual operation to automatic operation (the difference between automatic operation and manual operation).

The electricity consumption 301 represents the electricity consumption while the vehicle is running using the electric power of the battery 3. The fuel efficiency 302 represents the fuel efficiency when the vehicle 1 is a hybrid electric vehicle equipped with an engine and a motor 2 and travels using the engine. Energy saving information 303 represents the energy reduction effect due to traveling in automatic driving mode. Examples of the electricity cost ranking 304 include a ranking of electricity costs in the driver's own driving history based on comparison with personal driving information, and a ranking of electricity costs among drivers nationwide based on comparison with national driving information. The power saving power 305 can represent the power saving effect due to reducing the air volume of the air conditioner and information on converting the power saving amount into a charge. In this manner, the environmental/economic information priority mode can clearly present information indicating the environmental benefits of automatic driving and the economic benefits of power saving to the occupants of the vehicle 1.

For example, during the automatic driving mode, the display control ECU 40 can switch the display mode between a battery information priority mode and an environmental/economic information priority mode by accepting a selection by a passenger of the vehicle 1. The sensors 42 include a display mode changeover switch. When this switch is operated by a passenger while the vehicle 1 is automatically driving, the display control ECU 40 switches the display mode from the battery information priority mode to the environmental/economic information priority mode, or from the environmental/economic information priority mode to the battery information priority mode. Furthermore, by operating the sensors 42, it is also possible to individually select the information to be displayed on the display device 41, rather than the display mode itself. The display control ECU 40 generates a display image including information selected by the passenger of the vehicle 1 based on signals from an input unit included in the sensors 42, and displays the image data on the display device 41.

Further, when the driving mode is the automatic driving mode, the display control ECU 40 gives priority to the second display mode over the first display mode as the display mode. The display mode changeover switch included in the sensors 42 includes a switch for switching between a first display mode and a second display mode. In this case, the passenger of the vehicle 1 can select the first display mode even during automatic driving by operating the switch. In short, since the display control ECU 40 automatically selects the second display mode when the driving mode is switched to the automatic driving mode, the second display mode is prioritized over the first display mode when the driving mode is the automatic driving mode. Further, when the display mode is switched from the second display mode to the first display mode in response to a switch operation during automatic operation, the display control ECU 40 controls this display switching as a temporary switching. For example, if a predetermined period of time has passed since the display was switched during automatic operation, the display control ECU 40 automatically controls the display to return to the second display mode. In this way, the display control ECU 40 allows the display mode to be switched in response to a switch operation by the passenger during automatic driving, and gives priority to the second display mode over the first display mode. When the driving mode is the automatic driving mode, the display control ECU 40 determines the display mode to be either the battery information priority mode or the environmental/economic information priority mode.

As explained above, according to the embodiment, information displayed in the central display area of the display device 41 during the automatic driving mode is displayed in the central display area of the display device 41 in the first display mode corresponding to the manual driving mode. Different from the displayed information, information indicating the amount of energy saving achieved by traveling in the automatic driving mode can be displayed in the central display area of the display device 41. Thereby, the benefits of the vehicle 1 running in the automatic driving mode can be clearly communicated to the occupants of the vehicle 1.

Further, during automatic operation, the battery information 200 and the amount of energy saved can be displayed on the display device 41. Therefore, environmental benefits and economic benefits can be presented to the passengers of the vehicle 1. Furthermore, the passenger of the vehicle 1 can select the display screen of the display device 41 and the information he or she wishes to display.

Note that the display mode in the second display mode is not limited to the examples shown in FIGS. 3 and 4. For example, in the battery information priority mode, which is the third display mode of the second display mode, electricity consumption 301, fuel consumption 302, and energy saving information 303 are displayed as information indicating the amount of energy saved by driving in automatic driving mode. It is possible to display it in the central display area of the display unit 50. In short, in the second display mode, the information displayed in the central display area of the display device 41 only needs to include at least information indicating the amount of energy savings achieved by traveling in the automatic driving mode.

Further, the second display mode may include a normal display mode. The normal display mode as the second display mode displays images in the same first display mode as the first display mode. Furthermore, when the driving mode is the automatic driving mode, the display control ECU 40 prioritizes the battery information priority mode, which is the third display mode, over the normal display mode, which is the second display mode, regarding the display mode of the display device 41. do. Furthermore, when the driving mode is the automatic driving mode, the display control ECU 40 sets the display mode of the display device 41 to an environmental/economic information priority mode, which is a fourth display mode, rather than a normal display mode, which is a second display mode. Prioritize. In this case, when selecting the second display mode, the display control ECU 40 may give priority to either the battery information priority mode, which is the third display mode, or the environmental/economic information priority mode, which is the fourth display mode.

Further, in the first display mode, an image showing the amount of energy saving achieved by traveling in the manual driving mode may be displayed on the display device 41. In this case, an image showing the amount of energy saved by the manual operation mode is displayed in one of the display areas of the display unit 50 in the first display mode. In this case, when the operation mode is switched from the manual operation mode to the automatic operation mode, the display control ECU 40 switches the energy saving achieved from the manual operation to the automatic operation. Furthermore, the display control ECU 40 changes the display mode from the first display mode to the second display mode, and changes the display position from the predetermined display area to the central display area. Alternatively, in the first display mode, the image showing the amount of energy saving achieved by traveling in the manual driving mode may not be displayed on the display device 41. In this case, when switching to the second display mode, the amount of energy savings that was not displayed in the first display mode will be displayed. Therefore, the image indicating the amount of energy saving achieved is displayed as relatively more prominent information than in the first display mode.

What is claimed is:

1. A vehicle display control device mounted on a vehicle capable of switching a driving mode between a manual driving mode and an autonomous driving mode, the control device controlling a display device provided in a vehicle cabin of the vehicle, wherein:
a display mode of the display device is switched from a first display mode corresponding to the manual driving mode to a second display mode corresponding to the autonomous driving mode when the driving mode is switched from the manual driving mode to the autonomous driving mode; and
information indicating at least an amount of saved energy achieved by traveling in the autonomous driving mode is displayed in the second display mode.

2. The vehicle display control device according to claim 1, wherein:
an image indicating a cruising range of the vehicle during travel in the manual driving mode can be displayed in a display area of the display device in a first display manner as a predetermined display manner in the first display mode; and
an image indicating the amount of saved energy achieved by traveling in the autonomous driving mode is displayed in a central display area of the display area in a second display manner that is more conspicuous than the first display manner in the second display mode.

3. The vehicle display control device according to claim 2, wherein:
the vehicle is an electrified vehicle that includes a motor for travel and a battery that supplies power to the motor;
the second display mode includes a third display mode in which information related to the battery is preferentially displayed; and
an image indicating the amount of saved energy achieved by traveling in the autonomous driving mode and an image indicating a cruising range during travel of the vehicle with use of the power of the battery are displayed in the central display area in the second display manner in the third display mode.

4. The vehicle display control device according to claim 3, wherein:
the second display mode includes a normal display mode in which an image is displayed in the first display manner similar to the first display mode; and
the third display mode is given priority over the normal display mode as the display mode of the display device when the driving mode is the autonomous driving mode.

5. The vehicle display control device according to claim 3, wherein:
the second display mode includes
a normal display mode in which an image is displayed in the first display manner similar to the first display mode, and
a fourth display mode in which environmental information and economic information are preferentially displayed;
an image indicating the amount of saved energy achieved by traveling in the autonomous driving mode and an image indicating an electrical efficiency are displayed in the central display area in the second display manner in the fourth display mode; and
the fourth display mode is given priority over the normal display mode as the display mode of the display device when the driving mode is the autonomous driving mode.
